(19) United States
(12) Patent Application Publication
(10) Pub. No.: US 2014/0055579 A1
(43) Pub. Date: Feb. 27, 2014

(54) PARALLAX ADJUSTMENT DEVICE, THREE-DIMENSIONAL IMAGE GENERATION DEVICE, AND METHOD OF ADJUSTING PARALLAX AMOUNT

(71) Applicant: Panasonic Corporation, Osaka (JP)

(72) Inventor: Tadanori Tezuka, Fukuoka (JP)

(21) Appl. No.: 14/112,067

(22) PCT Filed: Feb. 20, 2013
(86) PCT No.: PCT/JP2013/000938

§ 371 Date: Oct. 16, 2013

(30) Foreign Application Priority Data
Mar. 2, 2012 (JP) 2012-046212

(51) Int. Cl. H04N 13/00

(52) U.S. Cl. CPC H04N 13/0022
USPC 348/51

(57) ABSTRACT

A parallax adjustment device includes: an obtainment unit which obtains parallax data indicating an amount of parallax for an input image; and a parallax adjustment unit which adjusts the amount of parallax indicated by the parallax data by converting the amount of parallax as an input amount of parallax into an output amount of parallax in accordance with a predetermined correlation between the input amount of parallax and the output amount of parallax, in which the predetermined correlation in a first range of the input amount of parallax shows that the output amount of parallax decreases with an increase in the input amount of parallax.

### TECHNICAL FIELD

The present invention relates to a technique of adjusting an amount of parallax in a three-dimensional image.

### BACKGROUND ART

As a conventional method of generating a three-dimensional image, a method of generating a pseudo three-dimensional image from an image using an amount of parallax is known (e.g., Patent Literature 1). In Patent Literature 1, the amount of parallax in the three-dimensional image is adjusted based on a parameter (such as the largest amount of pop out or the smallest amount of pop out).

### CITATION LIST

[Patent Literature]

[PTL 1] Japanese Unexamined Patent Application Publication No. 2003-209858

### SUMMARY OF INVENTION

[Technical Problem]

However, in the conventional method, it is sometimes difficult to appropriately adjust the amount of parallax. For instance, as a result of adjusting the amount of parallax, the stereoscopic effect of a three-dimensional image may be significantly degraded.

Therefore, the present invention provides a parallax adjustment device which can appropriately adjust an amount of parallax in the three-dimensional image.

[Solution to Problem]

A parallax adjustment device according to an aspect of the present invention includes: an obtainment unit which obtains parallax data indicating an amount of parallax for an input image; and a parallax adjustment unit which adjusts the amount of parallax indicated by the parallax data by converting the amount of parallax as an input amount of parallax into an output amount of parallax in accordance with a predetermined correlation between the input amount of parallax and the output amount of parallax, in which the predetermined correlation in a first range of the input amount of parallax shows that the output amount of parallax decreases with an increase in the input amount of parallax.

It should be noted that a general or specific aspect of these may be achieved by a system, a method, an integrated circuit, a computer program, or a computer-readable recording medium such as CD-ROM, or may be achieved by any combinations of systems, methods, integrated circuits, computer programs, and recording media.

[Advantageous Effects of Invention]

According to a parallax adjustment device according to an aspect of the present invention, an amount of parallax can be appropriately adjusted.

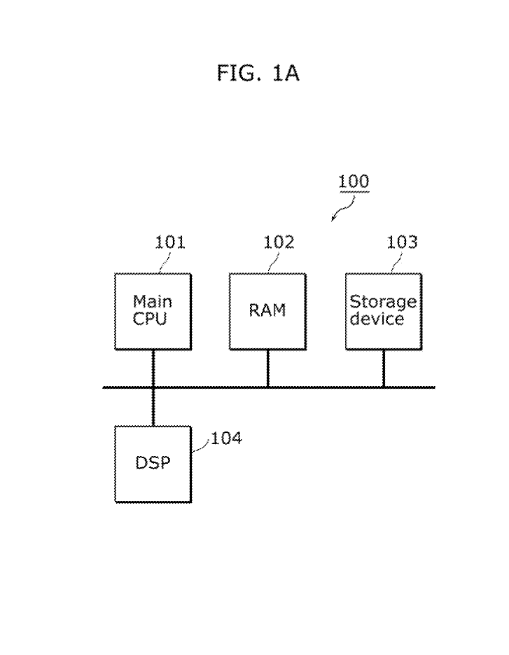

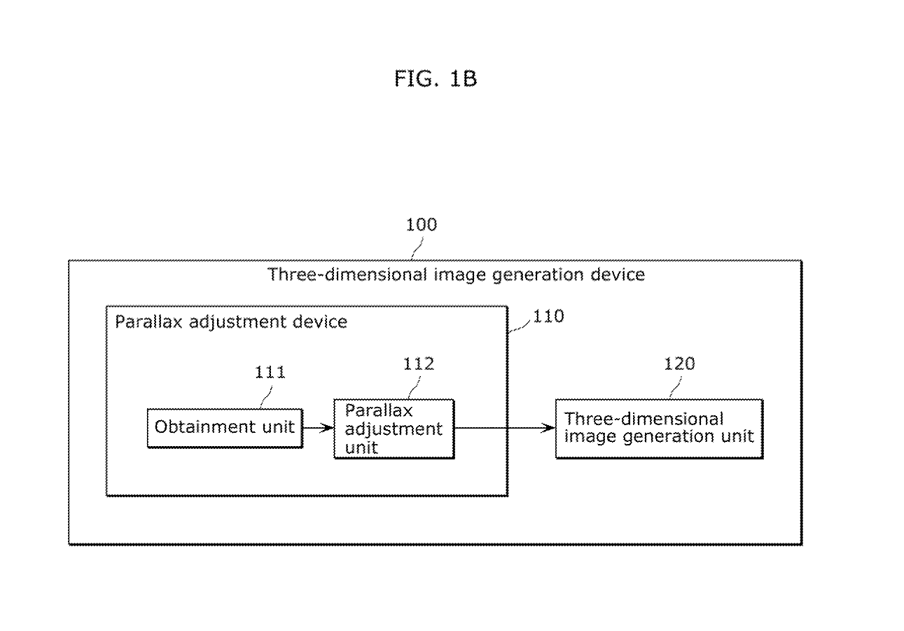

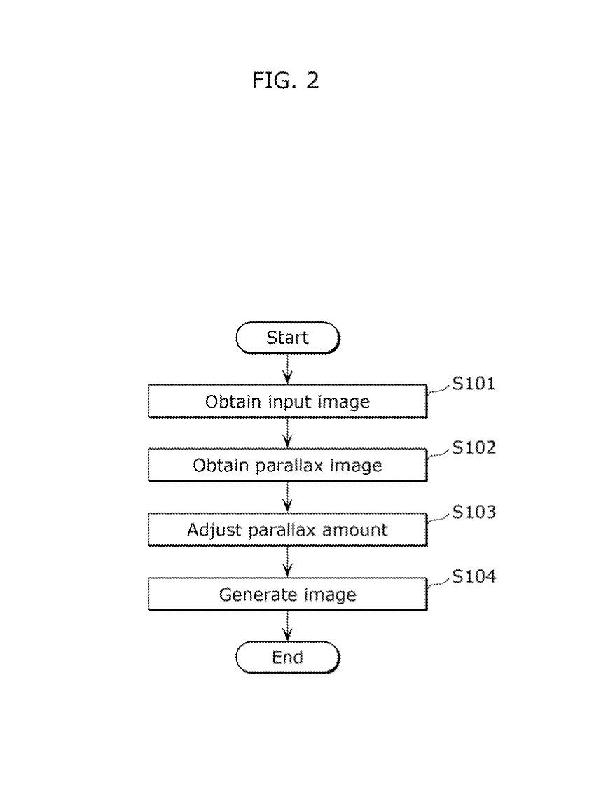

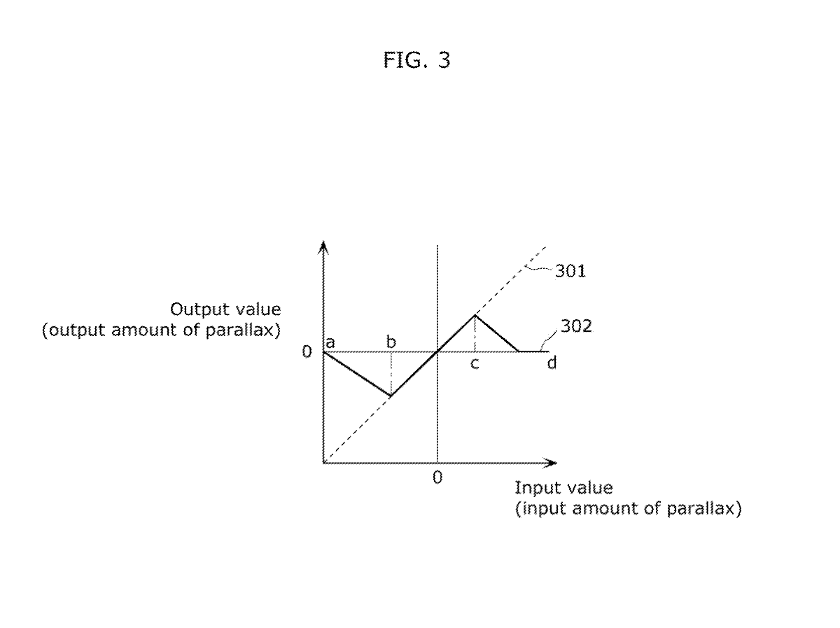

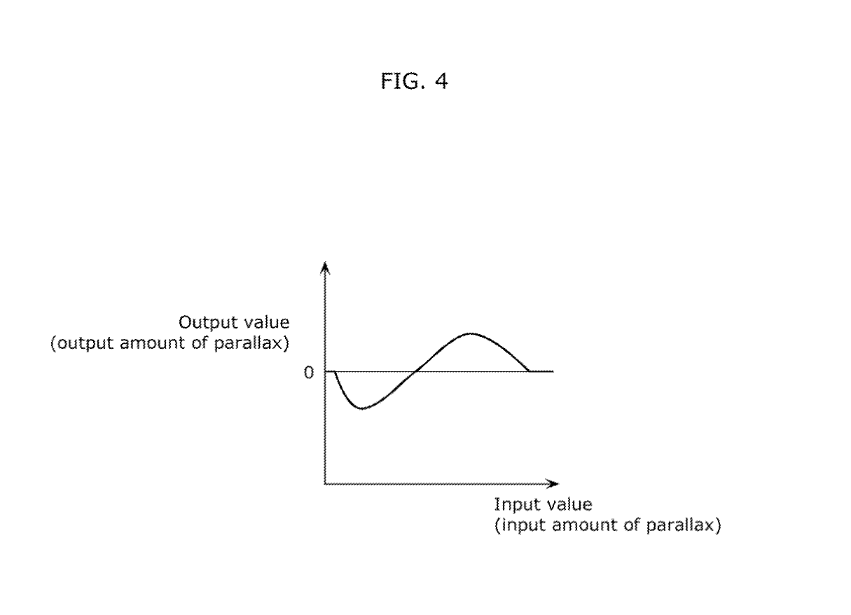

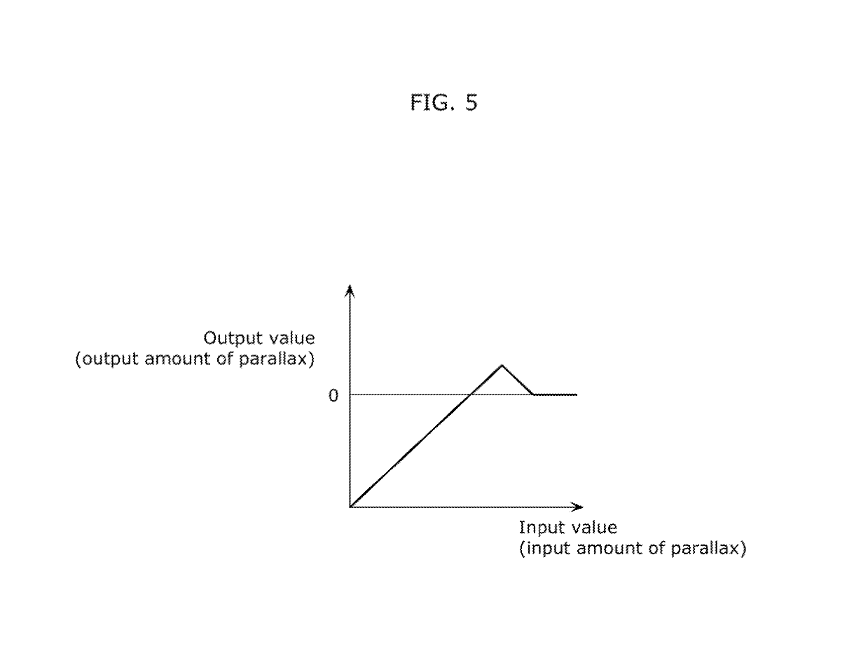

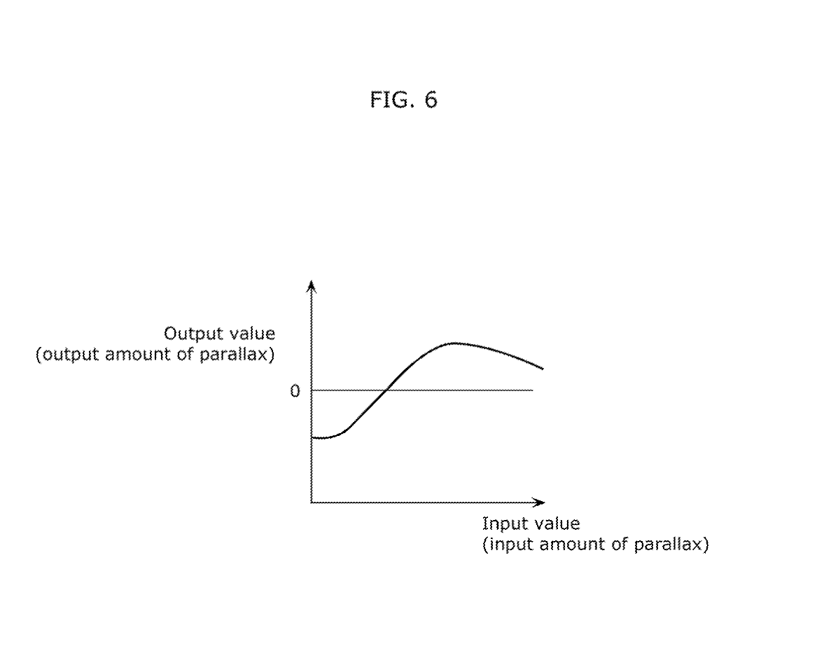

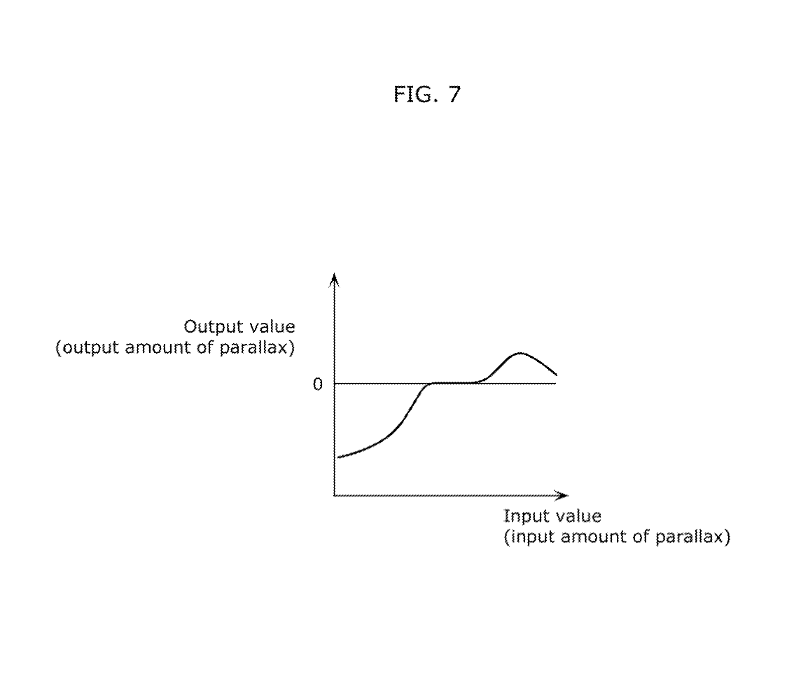

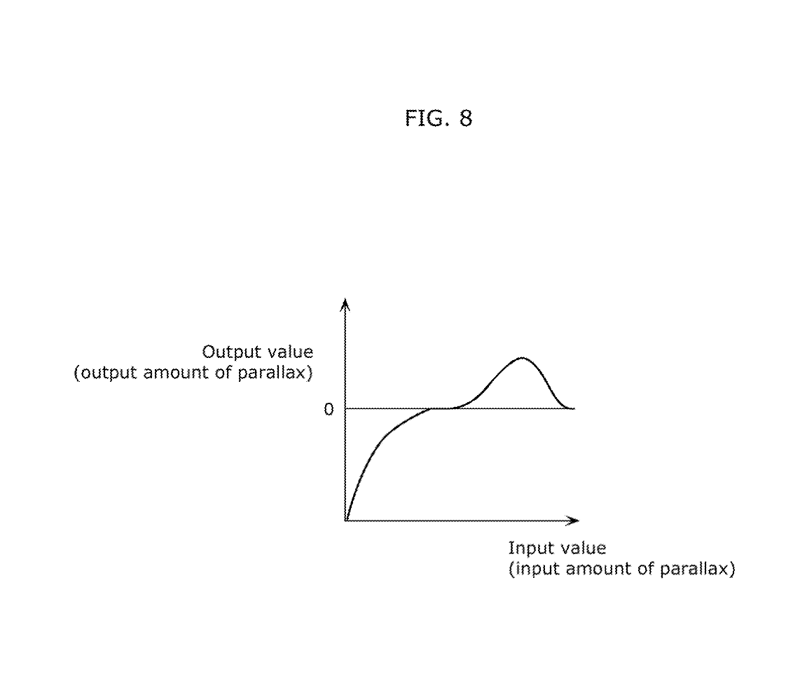

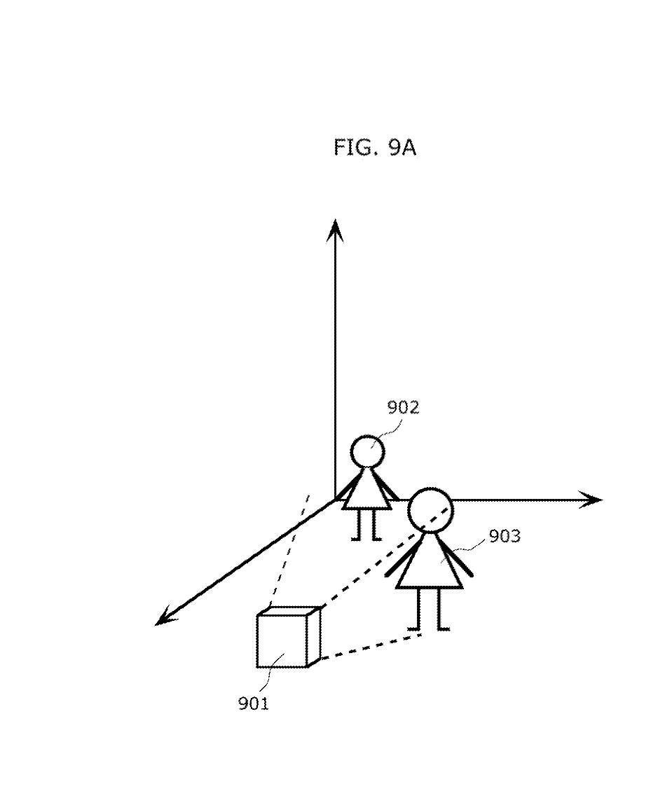

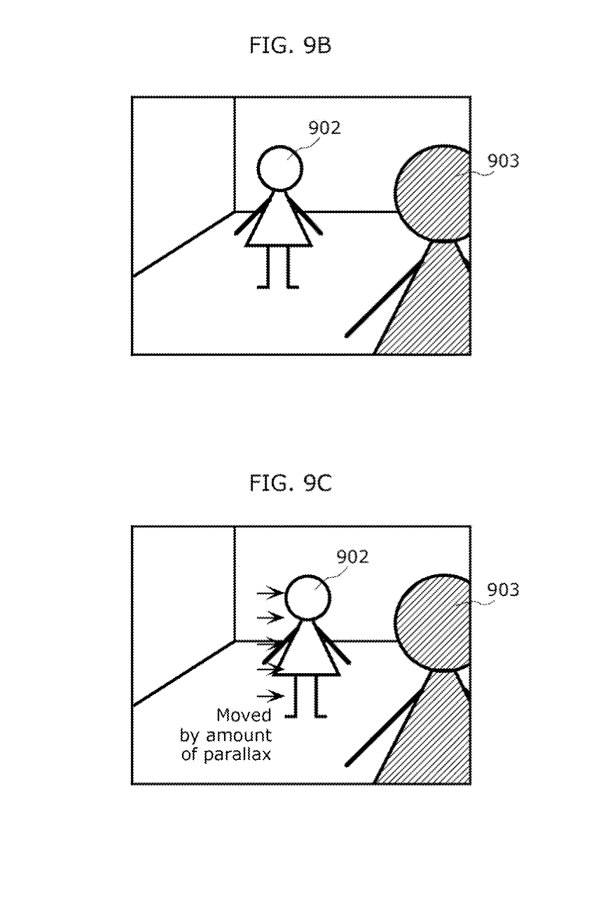

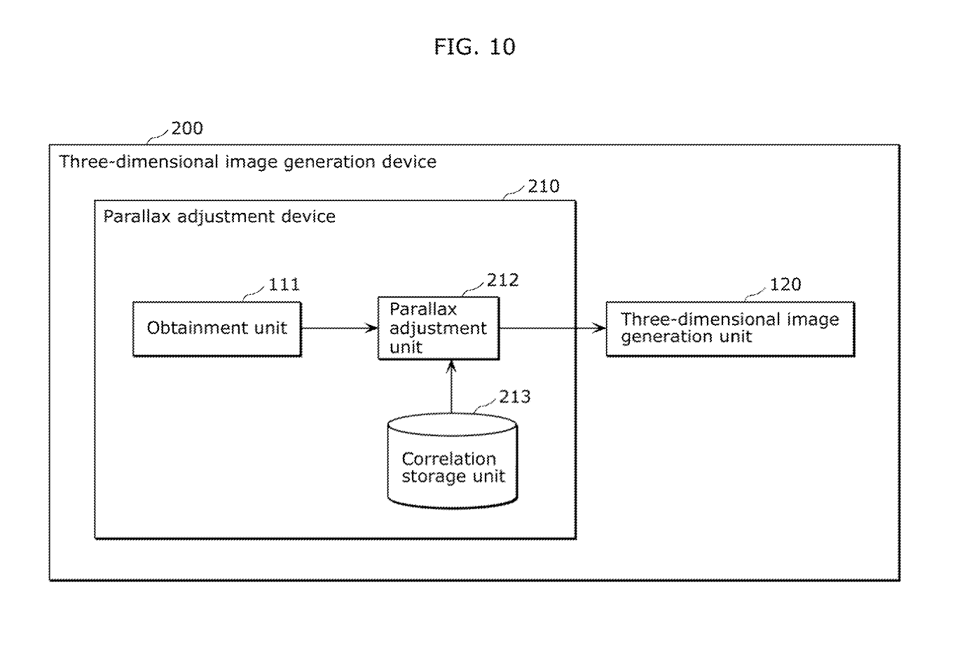

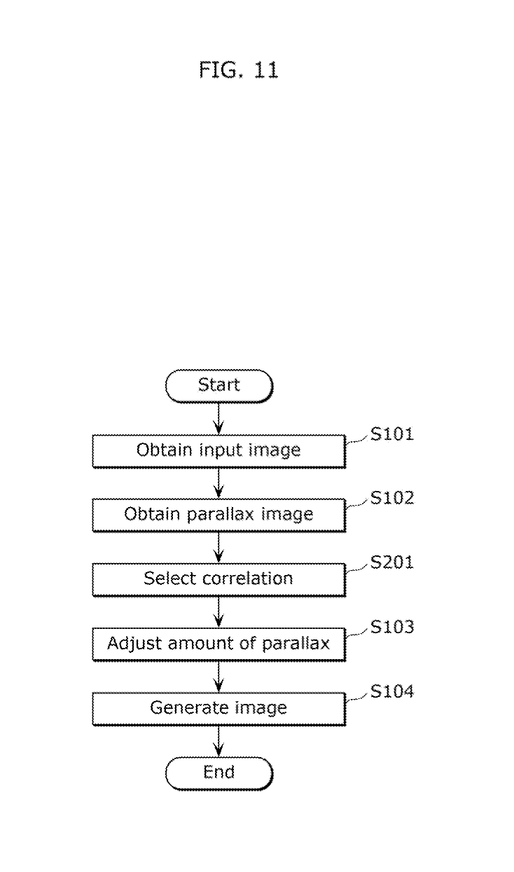

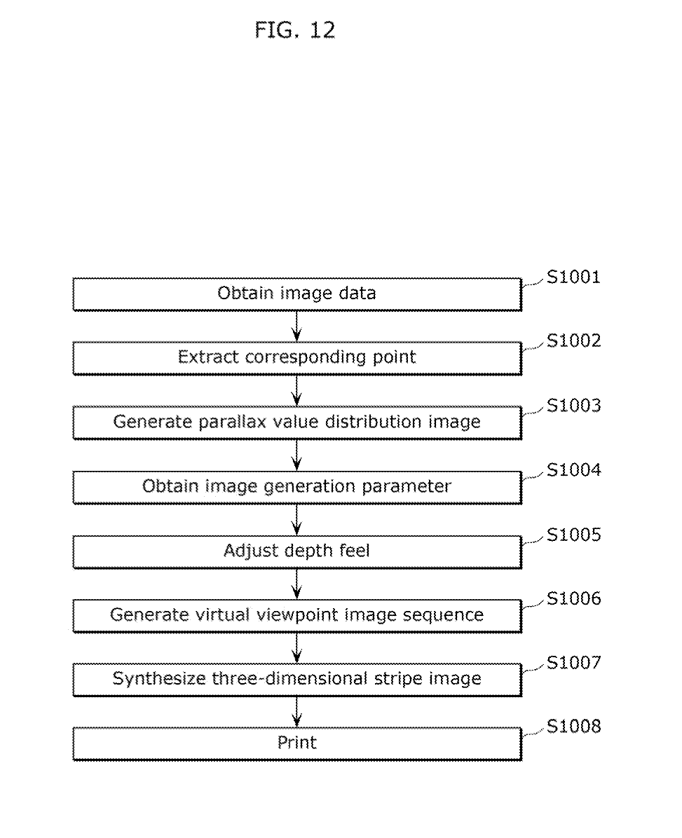

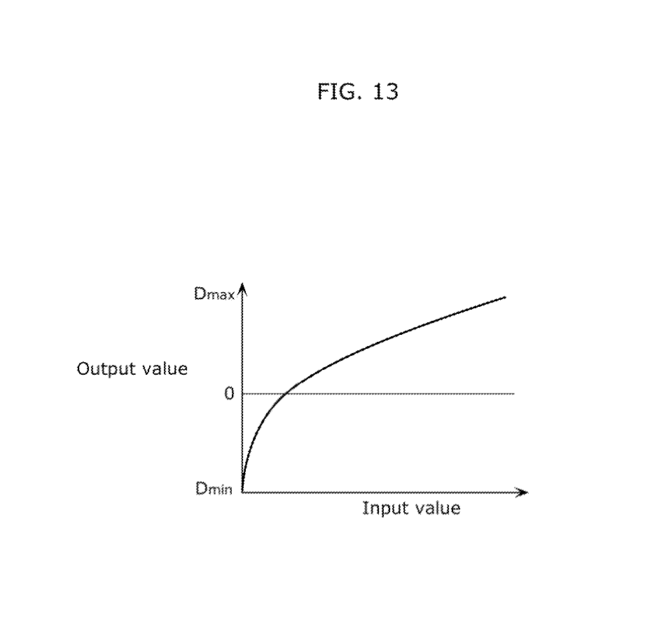

### BRIEF DESCRIPTION OF DRAWINGS

[FIG. 1A] FIG. 1A illustrates an example of the hardware configuration of a three-dimensional image generation device in Embodiment 1.

[FIG. 1B] FIG. 1B illustrates an example of the functional configuration of a three-dimensional image generation device in Embodiment 1.

[FIG. 2] FIG. 2 is a flowchart illustrating an example of the generation processing of a three-dimensional image in Embodiment 1.

[FIG. 3] FIG. 3 illustrates a first relationship between the input amount of parallax and the output amount of parallax in Embodiment 1.

[FIG. 4] FIG. 4 illustrates a second relationship between the input amount of parallax and the output amount of parallax in Embodiment 1.

[FIG. 5] FIG. 5 illustrates a third relationship between the input amount of parallax and the output amount of parallax in Embodiment 1.

[FIG. 6] FIG. 6 illustrates a fourth relationship between the input amount of parallax and the output amount of parallax in Embodiment 1.

[FIG. 7] FIG. 7 illustrates a fifth relationship between the input amount of parallax and the output amount of parallax in Embodiment 1.

[FIG. 8] FIG. 8 illustrates a sixth relationship between the input amount of parallax and the output amount of parallax in Embodiment 1.

[FIG. 9A] FIG. 9A is a figure for explaining an example of a three-dimensional image generated by a three-dimensional image generation device in Embodiment 1.

[FIG. 9B] FIG. 9B is a figure for explaining an example of a three-dimensional image generated by a three-dimensional mage generation device in Embodiment 1.

[FIG. 9C] FIG. 9C is a figure for explaining an example of a three-dimensional image generated by a three-dimensional image generation device in Embodiment 1.

[FIG. 10] FIG. 10 illustrates an example of the functional configuration of a three-dimensional image generation device in Embodiment 2.

[FIG. 11] FIG. 11 is a flowchart illustrating an example of the generation processing of a three-dimensional image in Embodiment 2.

[FIG. 12] FIG. 12 is a flowchart illustrating a conventional method of generating a three-dimensional image.

[FIG. 13] FIG. 13 is a graph showing a conventional relationship between the input amount of parallax and the output amount of parallax.

### DESCRIPTION OF EMBODIMENT

(Underlying Knowledge Forming Basis of the Present Disclosure)

The inventor of the present application has found that the following problem is caused regarding the adjustment of the amount of parallax recited in “Background Art”.

FIG. 12 is a flowchart illustrating a conventional method of generating a three-dimensional image. In FIG. 12, data for left and right images having a parallax is obtained (S1001), and corresponding points are extracted (S1002). A parallax value distribution image (parallax image) is created from the parallax between the positions of the corresponding points in the left and right images (S1003), and a depth value is obtained.

An image generation parameter is obtained (S1004). An amount of parallax is adjusted according to the obtained parameter, and depth feel is adjusted (S1005). An image from virtual viewpoints is generated from an input image based on this adjusted amount of parallax, and a three-dimensional image is obtained (S1006 to S1008).

Thus, an easy-to-view three-dimensional image is created by adjusting an amount of parallax using the parameter obtained in step S1004 (such as the largest amount of pop out or the smallest amount of pop out).

It should be noted that in step S1005, the amount of parallax is adjusted as shown in FIG. 13. In FIG. 13, while the horizontal axis represents the input value (input amount of parallax), the vertical axis represents the output value (output amount of parallax). For instance, in FIG. 13, excessive parallax in the three-dimensional image can be mitigated by adjusting the amount of parallax such that the larger the original amount of pop out is, the smaller the change in the adjusted amount of pop out is.

However, in the conventional method, when a three-dimensional image has a large amount of pop out, the amount of parallax for the entire image is adjusted to limit the amount of pop out to a certain range. This leads to a problem that the stereoscopic effect of a three-dimensional image is degraded.

Conversely, if the limits on the amount of pop out are diminished so as not to degrade the stereoscopic effect, the amount of parallax for the portion having a large amount of pop out remains large. Therefore, there is a problem in that the images of this portion are not fused and viewers may have double vision.

Therefore, a parallax adjustment device according to an aspect of the present invention includes: an obtainment unit which obtains parallax data indicating an amount of parallax for an input image; and a parallax adjustment unit which adjusts the amount of parallax indicated by the parallax data by converting the amount of parallax as an input amount of parallax into an output amount of parallax in accordance with a predetermined correlation between the input amount of parallax and the output amount of parallax, in which the predetermined correlation in a first range of the input amount of parallax shows that the output amount of parallax decreases with an increase in the input amount of parallax.

According to this configuration, the amount of parallax can be adjusted in accordance with a correlation showing that in a first range, the output amount of parallax decreases with an increase in the input amount of parallax. Therefore, the reduction of the amount of parallax and the maintenance of stereoscopic effect can be better balanced, and thus the amount of parallax can be more appropriately adjusted, compared to when the amount of parallax is adjusted in accordance with a correlation showing that in all ranges of the input amount of parallax, the output amount of parallax decreases with an increase in the input amount of parallax. For instance, the amount of parallax can be appropriately adjusted by matching, with the first range, the range of the amount of parallax for the portion whose amount of pop out should be reduced.

Moreover, for instance, in the first range, the input amount of parallax may have an absolute value greater than a threshold.

According to this configuration, the first range can be the range where the absolute value of the input amount of parallax is greater than the threshold. Therefore, it is possible to appropriately adjust the amount of parallax of the portion for which viewers are likely to have double vision due to the large absolute value of the amount of parallax.

Moreover, for instance, the input amount of parallax in the first range may be greater than zero, and the predetermined correlation in the first range may show that the output amount of parallax approximates zero with an increase in the input amount of parallax.

According to this configuration, in the range where the input amount of parallax is greater than zero, the amount of parallax can be adjusted in accordance with a correlation showing that the output amount of parallax approximates zero with an increase in the input amount of parallax. Therefore, it is possible to prevent the amount of pop out from becoming too large in a three-dimensional image, and alleviate the eye strain of the viewers.

Moreover, for instance, the input amount of parallax in the first range may less than zero, and the predetermined correlation in the first range may show that the output amount of parallax approximates zero with a decrease in the input amount of parallax.

According to this configuration, in the range where the input amount of parallax is less than zero, the amount of parallax can be adjusted in accordance with a correlation showing that the output amount of parallax approximates zero with a decrease in the input amount of parallax. Therefore, it is possible to prevent the amount of deep in from becoming too large in a three-dimensional image, and alleviate the eye strain of the viewers.

Moreover, for example, the predetermined correlation may further show that the input amount of parallax and the output amount of parallax coincide in a second range of the input amount of parallax.

According to this configuration, the amount of parallax can be adjusted in accordance with a correlation showing that the input amount of parallax and the output amount of parallax coincide in the second range. Therefore, it is possible to maintain the amount of parallax for the portion whose stereoscopic effect should be maintained. This can reduce the loss of the stereoscopic effect, which enables the appropriate adjustment of the amount of parallax.

Moreover, for instance, the parallax adjustment unit may further select the predetermined correlation from among a plurality of correlations between the input amount of parallax and the output amount of parallax according to properties of the input image.

According to this configuration, a correlation can be selected according to the properties of the input image. Therefore, the amount of parallax can be adjusted in accordance with a more appropriate correlation.

Moreover, for instance, the parallax adjustment unit may select the predetermined correlation from among the plurality of correlations according to an amount of parallax at a focus position in the input image.

According to this configuration, a correlation can be selected according to the amount of parallax at the focus position. Therefore, the amount of parallax can be adjusted without the loss of stereoscopic effect at the focus position.

Moreover, A three-dimensional image generation device according to an aspect of the present invention includes: the parallax adjustment device; and a three-dimensional image generation unit which generates a three-dimensional image using the input image and the adjusted amount of parallax.

According to this configuration, a three-dimensional image can be generated using the amount of parallax adjusted as described above.

It should be noted that a general or specific aspect of these may be achieved by a system, a method, an integrated circuit, a computer program, or a computer-readable recording medium such as CD-ROM, or may be achieved by any combinations of systems, methods, integrated circuits, computer programs, and recording media.

The following details embodiments with reference to drawings.

It should be noted that any embodiment described below shows a general or specific example. The numerical values, shapes, materials, structural elements, the arrangement and connection of the structural elements, steps, the processing order of the steps and so on shown in the following exemplary embodiments are mere examples, and therefore do not limit the scope of the appended Claims. Among structural elements in the following embodiment, structural elements not recited in the independent claims representing superordinate concept are arbitrary structural elements.

Moreover, excessive explanation may be omitted. For instance, detailed explanation for well-known matter or overlapped explanation for substantially the same structure may be omitted. This is for avoiding the redundancy of the following explanation and facilitating the understanding of those skilled in the art.

### [Embodiment 1]

(Configuration of three-dimensional image generation device)

FIG. 1A illustrates an example of the hardware configuration of a three-dimensional image generation device 100 in Embodiment 1. The three-dimensional image generation device 100 includes a main central processing unit (CPU) 101, a random access memory (RAM) 102, a storage device 103, and a digital signal processor (DSP) 104.

The main CPU 101 executes a program. Specifically, the main CPU 101 executes each coded command in a program loaded in the RAM 102.

The RAM 102 temporarily stores data such as a program and a parameter used when the program is executed.

The storage device 103 stores a program and data necessary for the operation of the main CPU 101. The storage device 103 is made of a memory card or a hard disk drive.

DSP 104 performs digital signal processing. The DSP 104 is equivalent to a sub-CPU.

The three-dimensional image generation device 100 generates a three-dimensional image by a program executed by the main CPU 101 or the DSP 104, a special hardware in the DSP 104, and the cooperative operations of these.

FIG. 1B illustrates an example of the functional configuration of a three-dimensional image generation device 100 in Embodiment 1. The three-dimensional image generation device 100 includes a parallax adjustment device 110 and a three-dimensional image generation unit 120.

As shown in FIG. 16, the parallax adjustment device 110 includes an obtainment unit 111 and a parallax: adjustment unit 112.

The obtainment unit 111 obtains parallax data. Here, the obtainment unit 111 obtains a parallax image as the parallax data.

The parallax data indicates amounts of parallax for an input image, It should be noted that the parallax data does not have to indicate the amounts of parallax themselves. For instance, the parallax data may be data indicating depths in an input image (such as a depth map). That is, the parallax data may be any data as long as the amounts of parallax for the input image can be obtained from the data.

The parallax image represents an amount of parallax for each pixel in the input image. That is, the parallax image represents the distribution of the amount of parallax for each pixel in the input image. It should be noted that the obtainment unit 111 may obtain data indicating the amount of parallax for each block of pixels instead of the parallax image.

The amount of parallax is a value indicating a parallax caused between multi-views when displaying an image three-dimensionally based on the input image. For instance, when the amount of parallax is “zero”, corresponding points (corresponding pixels) are displayed at the same position in the images of individual views, That is, when the amount of parallax is “zero”, the amount of pop out from a screen is “zero”.

The parallax adjustment unit 112 adjusts an amount of parallax indicated by the parallax data by converting the amount of parallax as an input amount of parallax into an output amount of parallax in accordance with a predetermined correlation between the input amount of parallax and the output amount of parallax. In the first range of the input amount of parallax, the correlation between the input amount of parallax and the output amount of parallax, which is used here shows that the output amount of parallax decreases with an increase in the input amount of parallax.

The three-dimensional image generation unit 120 generates a three-dimensional image using an input image and the adjusted amount of parallax. Specifically, the three-dimensional image generation unit 120, for example, generates a left-eye image having an amount of parallax adjusted for the input image (right-eye image) to generate a three-dimensional image made up of the right-eye image and the left-eye image.

(Operation of three-dimensional image generation device)

The following describes the operation of the three-dimensional image generation device 100 configured as above.

FIG. 2 is a flowchart illustrating an example of the generation processing of a three-dimensional image in Embodiment 1.

The obtainment unit 111 obtains an input image and a parallax image representing amounts of parallax for the input image (S101, S102). Specifically, the obtainment unit 111, for example, reads a pair of an input image and a parallax image stored in the storage device 103.

As the parallax image, a parallax image virtually generated by analyzing the input image or a parallax image generated by calculating parallax from the disparity between more than one image is used. It should be noted that the method of generating a parallax image is not limited to these.

The parallax adjustment unit 112 adjusts an amount of parallax indicated by a parallax image (S103). The three-dimensional image generation unit 120 generates a three-dimensional image using the input image and the adjusted amount of parallax (5104). The processing of these steps S103 and S104 will be detailed later.

The generated three-dimensional image is, for example, outputted to a display device. Moreover, the generated three-dimensional image may be stored in, for example, a recording medium. Here, the format of the three-dimensional image does not have to be limited to any particular format. For example, the format of the three-dimensional image may be a frame sequential, side by side, checkerboard, or anaglyph frame.

(Adjustment of amount of parallax)

The following details the adjustment of the amount of parallax in step S103 in FIG. 2.

As described above, the parallax adjustment unit 112 adjusts an amount of parallax indicated by the parallax data by converting the amount of parallax as an input amount of parallax into an output amount of parallax in accordance with a predetermined correlation between the input amount of parallax and the output amount of parallax. In the first range of the input amount of parallax, this correlation between the input amount of parallax and the output amount of parallax shows that the output amount of parallax decreases with an increase in the input amount of parallax.

That is, when the input amount of parallax is x, and the output amount of parallax is f(x), there is the range of x (first range) satisfying that df(x) dx<0.

FIG. 3 is a graph showing an example (first relationship) of the correlation between the input amount of parallax and the output amount of parallax in Embodiment 1. A broken line 301 is a straight line representing that the input amount of parallax is equal to the output amount of parallax. In the example in FIG. 3, the parallax adjustment unit 112 adjusts an amount of parallax indicated by the parallax image in accordance with the correlation represented by a solid line 302 (zigzag line).

Specifically, the parallax adjustment unit 112 adjusts the amount of parallax such that in the range of b-c (second range) where the input amount of parallax is around zero, the input amount of parallax is the output amount of parallax. That is, the correlation used here shows that the input amount of parallax and the output amount of parallax coincide in the second range of the input amount of parallax.

Meanwhile, in the range of a-b and the range of c-d (first range) where the absolute value of the input amount of parallax is greater than a threshold, the parallax adjustment unit 112 adjusts the amount of parallax such that the output amount of parallax decreases with an increase in the input amount of parallax. That is, in the first range where the absolute value of the input amount of parallax is greater than a threshold, the correlation used here shows that the output amount of parallax decreases with an increase in the input amount of parallax. Therefore, it is possible to appropriately adjust the amount of parallax of the portion for which viewers are likely to have double vision due to the large absolute value of the amount of parallax.

Specifically, in the range where the absolute value of the input amount of parallax is greater than a threshold, and the input amount of parallax is greater than zero, the correlation shows that the output amount of parallax approximates zero with an increase in the input amount of parallax. Specifically, in the range where the absolute value of the input amount of parallax is greater than a threshold, and the input amount of parallax is less than zero, the correlation shows that the output amount of parallax approximates zero with a decrease in the input amount of parallax. These can prevent the amounts of pop out and deep in from becoming too large in a three-dimensional image, and alleviate the eye strain of the viewers,

Moreover, in the example of FIG. 3, the correlation between the input amount of parallax and the output amount of parallax is shown by a straight line in the graph. Therefore, it is possible to calculate an output amount of parallax corresponding to an input amount of parallax by linear interpolation, and reduce the amount of processing necessary for adjusting an amount of parallax.

Here, the following describes other examples of the correlation between the input amount of parallax and the output amount of parallax.

FIG. 4 is a graph showing another example (second relationship) of the correlation between the input amount of parallax and the output amount of parallax in Embodiment 1. In the example in FIG. 4, the correlation between the input amount of parallax and the output amount of parallax is shown by a smooth curve. Moreover, as same as FIG. 3, the correlation shows that the output amount of parallax approximates zero in the range where the input amount of parallax is large, Discomfort sensed from a three-dimensional image due to abrupt change in the output amount of parallax when change in the input amount of parallax is small is diminished by using the correlation between the input amount of parallax and the output amount of parallax such that the output amount of parallax is smoothly changed in response to the change in the input amount of parallax.

FIG. 5 is a graph showing another example (third relationship) of the correlation between the input amount of parallax and the output amount of parallax in Embodiment 1. In the example in FIG, 5, the correlation between the input amount of parallax and the output amount of parallax shows that the output amount of parallax approximates zero only in the range where the input amount of parallax has a positive value. That is, in this example, only the amount of parallax for a portion having a large amount of pop out is adjusted.

FIG. 6 is a graph showing another example (fourth relationship) of the correlation between the input amount of parallax and the output amount of parallax in Embodiment 1. In the example in FIG. 6, in the first range, the correlation between the input amount of parallax and the output amount of parallax shows that the output amount of parallax approximates zero with an increase in the input amount of parallax. However, the output amount of parallax does not reach zero. For instance, when dispersion for the amounts of parallax is not so large in an input image, there is no need to adjust the amount of parallax to zero. Therefore, the correlation as shown in FIG. 6 may be used.

FIG. 7 is a graph showing another example (fifth relationship) of the correlation between the input amount of parallax and the output amount of parallax in Embodiment 1. In the example in FIG. 7, there is the range where the output amount of parallax is zero in the correlation between the input amount of parallax and the output amount of parallax. Moreover, the correlation shows that the output amount of parallax approximates zero in the range where the input amount of parallax is large. By adjusting the amount of parallax using such a correlation, when, for example, a viewer looks at the portion having the input amount of parallax corresponding to the range where the output amount of parallax is zero, the amount of parallax for an object of interest is zero. This makes the three-dimensional image an easy-to-view image.

FIG. 8 is a graph showing another example (sixth relationship) of the correlation between the input amount of parallax and the output amount of parallax in Embodiment 1. In the example in FIG. 8, how a curve is curved (e.g., convex function or concave function) is different between the range where the input amount of parallax has a positive value and the range where the input amount of parallax has a negative value, However, also in FIG. 8, in the range where the absolute value of the input amount of parallax is greater than a threshold, and the input amount of parallax has a positive value, the output amount of parallax approximates zero with an increase in the input amount of parallax. The adjustment of the amount of parallax in accordance with such a correlation enables the adjustment of the amount of parallax at the pop-out side and the amount of parallax at the deep-in side with different correlations.

As described above, in the range where the input amount of parallax is large (first range), any correlations show that the output amount of parallax approximates zero with an increase in the input amount of parallax. A three-dimensional image obtained by adjusting the amount of parallax in accordance with such a correlation is a visually contradicted image. However, an uninterested portion having a large amount of parallax is easy to view as a three-dimensional image as a whole when it is displayed at the amount of parallax which is close to zero, rather than when it is displayed at the original amount of parallax. Moreover, humans perceive a three-dimensional space using not only a parallax but also other information such as composition information. Therefore, even if an image is such a visually contradicted three-dimensional image, apparent discomfort is not sensed. Conversely, this resolves the difficulty in viewing due to the excessively large amount of parallax, and an easy-to-view image is obtained.

It should be noted that the correlations between the input amount of parallax and the output amount of parallax as illustrated in FIGS. 3 to 8 are each shown by, for example, a table in which pairs of an input amount of parallax and an output amount of parallax corresponding to the input amount of parallax are registered. In this case, the parallax adjustment unit 112 can convert an amount of parallax (input amount of parallax) indicated by a parallax image into an output amount of parallax by searching the table for an output amount of parallax corresponding to the amount of parallax indicated by the parallax image.

Moreover, when the input amount of parallax which matches the amount of parallax indicated by the parallax image is not registered in the table, the parallax adjustment unit 112 may calculate an output amount of parallax corresponding to the amount of parallax indicated by the parallax image by interpolating (e.g., linear interpolation, polynomial interpolation, or spline interpolation) an output amount of parallax using the output amount of parallax corresponding to an input amount of parallax similar to the amount of parallax indicated by the parallax image. This can reduce the number of pairs to be registered in the table.

Moreover, the correlation between the input amount of parallax and the output amount of parallax may be, for example, expressed by a function. In this case, the amount of data for showing correlations can be reduced.

It should be noted that the correlations between the input amount of parallax and the output amount of parallax are not limited to the correlations shown in FIGS. 3 to EL For example, in the range where the input amount of parallax has a value around zero, a correlation may show that the output amount of parallax decreases with an increase in the input amount of parallax. That is, in any range of the input amount of parallax, the correlation may show that the output amount of parallax decreases with an increase in the input amount of parallax.

(Generation of three-dimensional image)

The following details the generation of a three-dimensional image in step S104 in FIG. 2.

The three-dimensional image generation unit 20 generates a three-dimensional image using the amount of parallax adjusted by the parallax adjustment device 110. It should be noted that the method of generating a three-dimensional image used here is almost the same as the conventional method of generating a three-dimensional image using the amount of parallax. However, as the portion having a large amount of parallax is decreased, the amount of interpolation which is needed due to the occurrence of occlusion can be reduced. It should be noted that the detailed explanation for the method of generating a three-dimensional image is omitted since the explanation will be similar to that for the conventional method. The method disclosed in PTL 1 can be used, for example.

FIGS. 9A to 9C are figures for explaining an example of a three-dimensional image generated by the three-dimensional image generation device 100 in Embodiment 1, FIG. 9A illustrates the positional relationships between a camera 901 which captured an input image and a subject 902 and between the camera 901 and a subject 903. FIG. 9B shows a right-eye image (input image). FIG. 9C shows a generated left-eye image.

For the positional relationship as shown in FIG. 9A, the subject 903 has a greater amount of parallax than the subject 902. That is, when the amount of parallax is not adjusted, the subject 903 is displayed in front of the subject 902.

Here, when the amount of parallax is adjusted by the parallax adjustment device 110, the subject 903 is placed at the same position both in the right-eye image and the left-eye image as shown in FIG, 9C. That is, the amount of parallax for the subject 903 is zero, and the amount of pop out from the screen is regulated. Meanwhile, the position of the subject 902 in the left-eye image is horizontally shifted by the amount of parallax from the position of the subject 902 in the right-eye image in FIG. 9B.

If the subject 902 is the portion of interest in the three-dimensional image made up of the right-eye image and the left-eye image, viewers would not care that the amount of parallax of the subject 903 is zero. Moreover, flicker which occurs when the amount of parallax is too large does not occur. This means that as shown in FIGS. 9B and 9C, the three-dimensional image generation device 100 can generate an easy-to-view three-dimensional image without degrading the stereoscopic effect of the portion of interest (subject 902).

Thus, according to the parallax adjustment device 110 in the present embodiment, the amount of parallax can be adjusted in accordance with a correlation showing that in the first range, the output amount of parallax decreases with an increase in the input amount of parallax. Therefore, compared to when the amount of parallax is adjusted in accordance with a correlation showing that in all ranges of the input amount of parallax, the output amount of parallax increases with an increase in the input amount of parallax, the reduction of the amount of parallax and the maintenance of stereoscopic effect can be better balanced, and thus the amount of parallax can be more appropriately adjusted, For instance, the amount of parallax can be appropriately adjusted by matching, with the first range, the range of the amount of parallax for a portion whose amount of pop out should be reduced.

It should be noted that although the three-dimensional image generation unit 120 generates the left-eye image using an input image as the right-eye image, it may generate the right-eye image using the input image as the left-eye image. Moreover, the three-dimensional image generation unit 120 may generate both a right-eye image and a left-eye image from an input mage.

### [Embodiment 2]

The following describes Embodiment 2. The major difference between the present embodiment and Embodiment 1 is in that the correlation between the input amount of parallax and the output amount of parallax is determined adaptively according to the properties of an input image, The following mainly describes the difference from Embodiment 1 regarding a three-dimensional image generation device in the present embodiment.

(Configuration of three-dimensional image generation device)

FIG. 10 is an example of the functional configuration of a three-dimensional image generation device 200 in Embodiment 2. The three-dimensional image generation device 200 includes a parallax adjustment device 210 and a three-dimensional image generation unit 120. The parallax adjustment device 210 includes an obtainment unit 111, a parallax adjustment unit 212, and a correlation storage unit 213.

The parallax adjustment unit 212 obtains the properties of an input image, Subsequently, the parallax adjustment unit 212 selects a correlation from among correlations between the input amount of parallax and the output amount of parallax according to the properties of the input image. The parallax adjustment unit 212 adjusts an amount of parallax indicated by a parallax image by converting the amount of parallax as an input amount of parallax into an output amount of parallax in accordance with the selected correlation.

For instance, the parallax adjustment unit 212 selects a correlation according to the amount of parallax at the focus position in an input image. Specifically, the parallax adjustment unit 212 selects the correlation in which the amount of parallax at the focus position in the input image is not included in the first range.

It should be noted that the focus position may be, for example, obtained as a parameter from an image capturing device, or determined by analyzing the input image. For instance, the focus position may be determined by analyzing positions including a large amount of high frequency components in the input image. Moreover, the parallax adjustment unit 212 may obtain the amount of parallax at the focus position instead of the focus position.

The correlation storage unit 213 stores correlations between the input amount of parallax and the output amount of parallax. Specifically, the correlation storage unit 213 stores, for example, the correlations shown in FIGS. 3 to 8. Here, at least one of the stored correlations shows that in the first range, the output amount of parallax decreases with an increase in the input amount of parallax.

(Operation of three-dimensional image generation device)

The following describes the operations of the three-dimensional image generation device 200 configured as above.

FIG. 11 is a flowchart illustrating the generation processing of a three-dimensional image in Embodiment 2.

After an input image and a parallax image are obtained (5101 and S102), the parallax adjustment unit 212 selects a correlation according to the properties of the input image (5201). As same as Embodiment 1, the parallax adjustment unit 212 adjusts the amount of parallax indicated by the parallax image using the selected correlation (S103). As same as Embodiment 1, the three-dimensional image generation unit 120 generates a three-dimensional image (S103 and S104).

Thus, according to the three-dimensional image generation device 200 in the present embodiment, a correlation can be selected according to the properties of an input image. This enables the adjustment of the amount of parallax in accordance with a more appropriate correlation. Especially, it is possible to adjust the amount of parallax without the loss of stereoscopic effect at a focus position by selecting a correlation according to the amount of parallax at the focus position.

It should be noted that the three-dimensional image generation device 200 does not necessarily have to include the correlation storage unit 213. In this case, the three-dimensional image generation device 200 may, for example, obtain a correlation from a storage device connected thereto via the network.

It should be noted that the parallax adjustment unit 212 may, for example, select a correlation according to the amount of parallax at a portion of interest in an input image. More specifically, the parallax adjustment unit 212 may select a correlation in which the amount of parallax at the portion of interest in the input image is not included in the first range.

For example when the input image is a part of a video of a soccer game, the portion of interest corresponds to, for example, the portion showing a soccer ball. Such a portion of interest may be given as a parameter or determined by analyzing the input image.

Moreover, the parallax adjustment unit 212 may select a correlation according to dispersion for amounts of parallax in a parallax image. More specifically, when a value indicating the dispersion for the amounts of parallax in the parallax image (such as a variance) is less than a threshold, the parallax adjustment unit 212 may select the correlation as shown in FIG. 6.

Although the three-dimensional image generation device and the parallax adjustment device according to one or more aspects were described based on the embodiment, the present invention is not limited to the present embodiment. The one or more aspects may include, without departing from the scope of the present invention, an embodiment obtained by making various modifications which those skilled in the art would conceive to the present embodiment, or an embodiment obtained by combining structural elements in different embodiments.

For instance, although in each embodiment described above, the parallax adjustment device is included in the three-dimensional image generation device, it does not have to be included in the three-dimensional image generation device. For instance, the parallax adjustment device may be independent from the three-dimensional image generation device. In this case, the parallax adjustment device may, for example, send an adjusted amount of parallax to the three-dimensional image generation device via a memory medium or a communication medium.

It should be noted that in the above embodiment, each structural element may be a dedicated hardware or may be achieved by executing a software program suitable for the each element. A program execution unit such as a CPU or a processor may read and execute a software program recorded in a recording medium such as a hard disk or a semiconductor memory to achieve the each element. Here, software which achieves a parallax adjustment device and others in the above embodiments is described below.

That is, this program causes a computer to execute a method of adjusting an amount of parallax including: obtaining parallax data indicating the amount of parallax for an input image; and adjusting the amount of parallax indicated by the parallax data by converting the amount of parallax as an input amount of parallax into an output amount of parallax in accordance with a predetermined correlation between the input amount of parallax and the output amount of parallax, in which the predetermined correlation in a first range of the input amount of parallax shows that the output amount of parallax decreases with an increase in the input amount of parallax.

### [Industrial Applicability]

A parallax adjustment device and a three-dimensional image generation device according to an aspect of the present invention are useful as devices for generating an easy-to-view 3D image by adjusting parallax.

### [Reference Signs List]

100, 200 three-dimensional image generation device

101 main CPU

102 RAM

103 storage device

104 DSP

110, 210 parallax adjustment device

111 obtainment unit

112, 212 parallax adjustment unit

120 three-dimensional image generation unit

1. A parallax adjustment device comprising:
an obtainment unit configured to obtain parallax data indicating an amount of parallax for an input image; and
a parallax adjustment unit configured to adjust the amount of parallax indicated by the parallax data by converting the amount of parallax as an input amount of parallax into an output amount of parallax in accordance with a predetermined correlation between the input amount of parallax and the output amount of parallax,
wherein the predetermined correlation in a first range of the input amount of parallax shows that the output amount of parallax decreases with an increase in the input amount of parallax.

2. The parallax adjustment device according to claim 1,
wherein in the first range, the input amount of parallax has an absolute value greater than a threshold.

3. The parallax adjustment device according to claim 2,
wherein in the first range,
the input amount of parallax is greater than zero, and
the predetermined correlation shows that the output amount of parallax approximates zero with an increase in the input amount of parallax.

4. The parallax adjustment device according to claim 2,
wherein in the first range,
the input amount of parallax is less than zero, and
the predetermined correlation shows that the output amount of parallax approximates zero with a decrease in the input amount of parallax.

5. The parallax adjustment device according to claim 1, wherein the predetermined correlation further shows that the input amount of parallax and the output amount of parallax coincide in a second range of the input amount of parallax.

6. The parallax adjustment device according to claim 1, wherein the parallax adjustment unit is further configured to select the predetermined correlation from among a plurality of correlations between the input amount of parallax and the output amount of parallax according to properties of the input image.

7. The parallax adjustment device according to claim 6,
wherein the parallax adjustment unit is configured to select the predetermined correlation from among the plurality of correlations according to an amount of parallax at a focus position in the input image.

8. The parallax adjustment device according to claim 1,
the parallax adjustment device being configured as an integrated circuit.

9. A three-dimensional image generation device comprising:
the parallax adjustment device according to claim 1; and
a three-dimensional image generation unit configured to generate a three-dimensional image using the input image and the adjusted amount of parallax.

10. A method of adjusting an amount of parallax comprising:
obtaining parallax data indicating the amount of parallax corresponding to an input image; and
adjusting the amount of parallax indicated by the parallax data by converting the amount of parallax as an input amount of parallax into an output amount of parallax in accordance with a predetermined correlation between the input amount of parallax and the output amount of parallax,
wherein the predetermined correlation in a first range of the input amount of parallax shows that the output amount of parallax decreases with an increase in the input amount of parallax.

11. A computer-readable non-transitory recording medium having recorded thereon a program for causing a computer to execute the method of adjusting an amount of parallax according to claim 10.
